(19) United States
(12) Patent Application Publication
(10) Pub. No.: US 2008/0313574 A1
(43) Pub. Date: Dec. 18, 2008

(54) SYSTEM AND METHOD FOR SEARCH WITH REDUCED PHYSICAL INTERACTION REQUIREMENTS

(75) Inventors: Murali ARAVAMUDAN, Windham, NH (US); Sankar ARDHANARI, Windham, NH (US); Viswanathan THIAGARAJAN, Bangalore (IN)

Correspondence Address: WILMERHALE/BOSTON, 60 STATE STREET, BOSTON, MA, 02109, US

(73) Assignee: Veveo, Inc., Andover, MA (US)

(21) Appl. No.: 12/123,940

(22) Filed: May 20, 2008

Related U.S. Application Data
(60) Provisional application No. 60/940,182, filed on May 25, 2007.

(51) Int. Cl. G06F 3/048

(52) U.S. Cl. 715/854

(57) ABSTRACT

A user-interface method and system for displaying a set of search results on a user device having a limited display area and having a five-button interface, where a user may explicitly or implicitly choose a search result to be expanded in order to provide space for displaying additional metacontent related to the selected search result, and where the expansion of the chosen search result does not occlude information displayed about other search results.

### CROSS-REFERENCE TO RELATED APPLICATIONS

This application claims the benefit under 35 U. S.C. §119(e) of the following application, the contents of which are incorporated by reference herein:

U.S. Provisional Application No. 60/940,182, entitled Method and System for Search with Reduced Physical Interaction Requirements, filed May 25, 2007.

### BACKGROUND

1. Field of the Invention

The present invention relates generally to user-interface methods for forming search-engine queries and navigating search results and, more specifically, to methods that allow users of input-constrained and display-constrained devices to effectively interact with search engines.

2. Discussion of Related Art

One-handed operation is a key factor governing the usability of many input constrained devices. For example, when using mobile phones or remote controls for televisions, having both hands free is more the exception than the norm. For this reason, such devices often include hardware that is specifically designed for efficient one-handed operation (e.g., the Blackberry scroll wheel, the mobile telephone five-button control, etc.). To maximize usability and efficiency, software interfaces must also be tailored to the limitations of mobile devices and the needs of mobile users. For example, because pressing buttons with only one hand is often slow, and can be physically uncomfortable, mobile interfaces should preferably be designed to allow users to navigate between content items using as few keypresses as possible.

Mobile devices are generally display-constrained as well as input-constrained. Of necessity, portable devices have small screens that can display only a limited amount of information at one time, and it is therefore important for mobile interfaces to make the most of the available screen space. Interface components designed for larger devices, such as, e.g., pop-up menus and dialog windows, which are commonly used in interfaces for personal computers, generally do not scale well to mobile devices, as discussed below.

Searching for content typically involves the following sequence of actions: (1) text input of a search query, (2) navigation of the query results to find the result of interest, (3) picking the desired result, and (4) performing an action associated with the result. While the effort expended in step two can be significantly influenced by the quality of results returned by search, this step can still take significant time, particularly in search domains (such as web video) where users must navigate to a result and examine its metacontent in order to evaluate its relevant.

Several approaches to reduce the number of steps in the discovery process are currently being used, even in the desktop domain, where display and input limitations are not as severe. For example, the space allocated for each result may be minimized to allow for more results to be displayed. This increases the likelihood that the user will be able to locate the desired result by scanning a single page of results without having to browse or scroll through results that are not of interest. At the same time, search interfaces must balance the amount of metacontent that is displayed for each result and the number of results displayed. If less metacontent is displayed with each result, more results can be displayed on the screen at one time. However, reducing the amount of metacontent makes it harder for the user to evaluate search results. Other approaches seek to streamline the final stage of the search process by providing easy access to the actions associated with the search result selected by the user.

FIG. 1 illustrates four existing approaches to user interface layout that are intended to mitigate some of the difficulties mentioned above. In these interfaces, the rows labeled “Result n” [102] represent search results, the grayed-out rows [104] represent the currently highlighted search results, and the rows labeled “Action n” [108, 112] or “An” [124] represent user-selectable actions associated with the highlighted search results (e.g. “go to link”, “play video”, “find similar items”, etc.). In prior art interfaces I and II [100, 110], the list of actions associated with the current result is displayed in a separate popup menu, which may be displayed, e.g., above the selected search result [106] or below it [114], and which is either dismissed by an explicit “close popup” action or by performing another action, such as clicking on another result. This approach has several drawbacks, most notably the fact that is separates the search result from associated menu of actions, when logically these two items should be displayed together. Also the popup menu often obscures the other search results in the list. The Palm Treo family of products have interfaces that employ this paradigm.

Prior art interface III is a conventional dialog-box based interface [120] that further decouples the search result from the actions menu by using an intrusive overlay window [122]. In some cases, this overlay may appear over the selection itself or metacontent associated with the selection, and may also obscure other search results, all of which may be undesirable. The Sony Ericsson 580i has an interface similar to this one.

Collapsible and expandable tree-like interfaces like prior art interface IV [130] have been used on devices such as personal computers to present an arrangement of folders and subfolders. However, this type of interface is designed for point-and-click interfaces that are difficult to use with one hand.

Expanding a result in a tree-like interface is burdensome to the user because expanding a top-level item [104] increases the length of the list, thereby pushing lower placed results listings off of the screen. Thus, the user is forced to navigate through the entire expanded list in order to reach results outside the expanded set that fall lower in the result list (such as “Result 6”). In addition, once a user has scrolled down the branches of an expanded tree, the user must return to the top level to collapse the expanded branches. Thus, while tree-like interfaces tend toward increasing the amount of information rendered, the techniques described herein focus on selective expansion of information. Furthermore, tree-like interfaces do not display actions on the same row as the result.

Likewise, scrolling below the last item in the expanded tree branch or above the first item in the branch often does not automatically collapse the expanded tree. Thus, as the user scrolls down the list of a tree-like interface and expands multiple branches without closing previously expanded branches, the availability of space for non-expanded items is reduced. In addition, the burden on the user to return to results above those with expanded branches is increased, as the user must scroll past the expanded branches to reach the results higher in the list.

The limitations of mobile devices such as cell phones, television remote controls and PDAs present several difficulties that user interfaces must take into account. Mobile user interfaces must allow users to comfortably perform complex operations with only one hand, and must be able to efficiently display results to the user in a very limited space. In particular, a search interface running on such a device should (1) require as little input from the user as possible when constructing and launching a search query; and (2) allow the user to select a search result and act on it with minimal delay. The present invention addresses both of these issues.

### SUMMARY OF THE INVENTION

This invention provides user-interface methods and systems for displaying a set of search results on a user device having a limited display area and having a five-button control interface, the method comprising receiving a set of search results, subdividing the screen into rows, where each row displays a result and some metadata associated with that result, navigating through the rows using the up- and down-arrow keys, expanding the current row in response to an implicit or explicit user selection, using the additional space to display more metacontent about the current result and a horizontal array of user actions based on the current result, and using the left- and right-arrow keys to navigate among these user actions, such that a user can navigate among results and actions using only the keys of the five-button control interface.

Under another aspect of the invention, a row is expanded when it has been the current row for a predetermined amount of time, thereby triggering an implicit selection of the current row.

Under another aspect of the invention, a row is expanded only when it has been explicitly selected by the user using the select-button.

Under another aspect of the invention, the metadata displayed in both the unexpanded and the expanded rows is limited to a predetermined size.

Under another aspect of the invention, an image related to the current result is displayed within the expanded row.

Under another aspect of the invention, the array of user actions contains an unexpand-row action.

Under another aspect of the invention, the array of user actions contains a navigate-to-link action.

### BRIEF DESCRIPTION OF THE DRAWINGS

For a more complete understanding of various embodiments of the present invention, reference is now made to the following descriptions taken in connection with the accompanying drawings in which:

FIG. 1 depicts various types of mobile user interfaces that exist in the prior art.

FIG. 2 is a network diagram that illustrates a search system in which several different client devices are connected to a server farm via a distribution network, according to certain embodiments of the invention

FIG. 3 illustrates a user interface for displaying search results in both the expanded and unexpanded states, according to certain embodiments of the invention.

FIG. 4 is a flowchart that illustrates the user interface logic for discovering a result and acting upon it, according to certain embodiments of the invention.

FIG. 5 is a diagram that depicts a client device, according to certain embodiments of the invention.

### DETAILED DESCRIPTION

Preferred embodiments of the present invention provide user-interface methods and systems for forming search queries and browsing and evaluating search results that require a minimum of user interaction. Preferred embodiments allow the user to expand a particular search result in a result list using either explicit selection techniques (e.g. clicking on the search result) or implicit selection techniques (e.g. by allowing the cursor to remain in the row for a certain amount of time). Expanding a particular result permits the interface to display more metadata related to the result.

The expanded row also includes a list of actions relevant to the selected result (e.g. “navigate to link”, “play video”, “find similar items”, etc.). Displaying the action menu in the selected row (and not, e.g., as a popup window) has several advantages. First, since the menu is spatially close to the expanded result, it does not require the user to spend time looking for and navigating to the desired action. Second, it allows other, non-expanded results to be displayed at the same time, and does not monopolize the browsing process. Preferably, the action menu is displayed horizontally, so the user can use up-down cursor movement to navigate between results, and left-right cursor movement to navigate between actions. Alternatively, in applications where search results are displayed horizontally, the actions associated with a result would preferably be arrayed vertically.

According to a preferred embodiment, the user-interface techniques disclosed herein operate on devices with a five-button interface, comprising four directional buttons and a select button. However, the principles disclosed herein may be used with other types of navigation interfaces. Also, while the techniques are described below in the context of a search system, they may be effectively used in any application that involves browsing, reviewing, and selecting data elements.

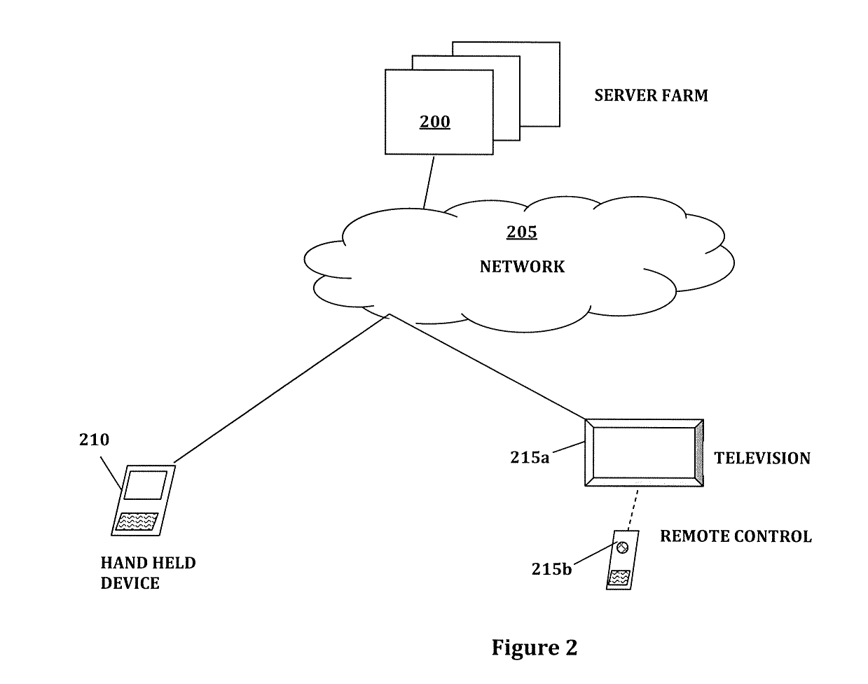

FIG. 2 is a network diagram that illustrates a search system in which several different client devices [210, 215a-b] are connected to a server farm [200] via a distribution network [205], according to certain embodiments of the invention. The client devices formulate search queries and send these queries over the distribution network to the server farm. The server farm executes the received queries against, e.g., a computer database of search data, which returns relevant search results. These results are sent back to the appropriate client devices, where, preferably, they are presented to users using a graphical user interface.

The distribution framework can be any network of wired and wireless connections, such as a cable television network, a satellite television network, an IP-based television network, wireless CDMA and GSM network, or a hybrid network that uses various communication technologies. The search devices (i.e. client devices) may have a wide range of interface capabilities such as a hand-held device [210] (e.g., a telephone or PDA) with limited display size and a reduced keypad with overloaded keys, or a television [215a] coupled with a remote control device [215b] having an overloaded keypad. Alternatively, the interface techniques described below may be used in systems where the client device executes the user's queries locally and displays the results without connecting to a network.

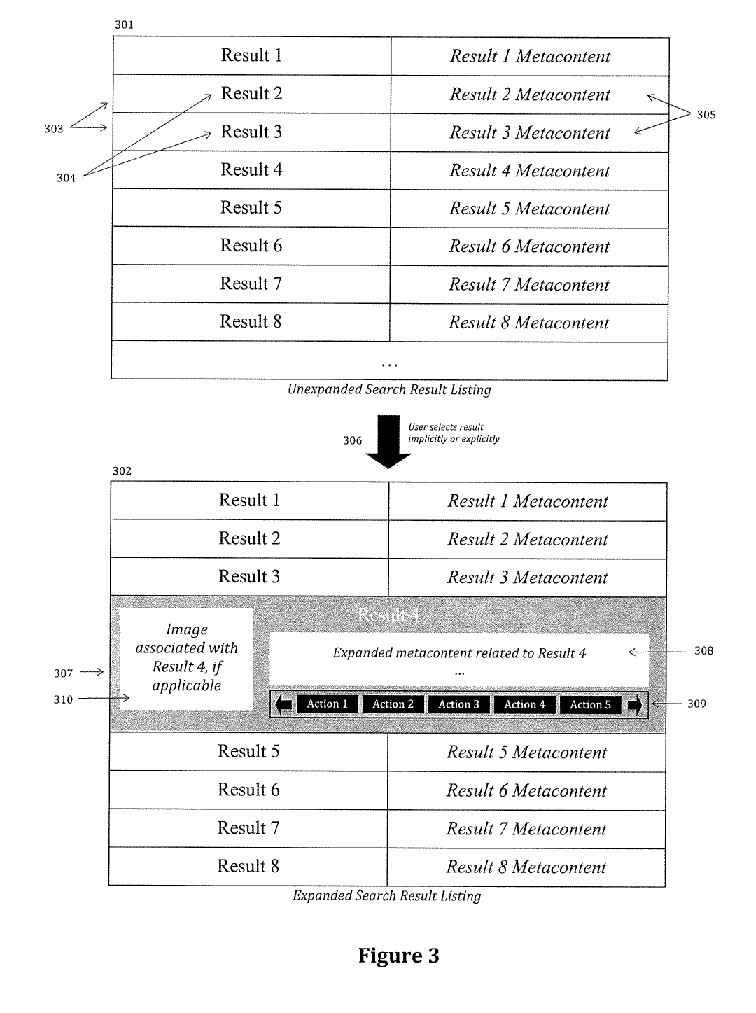

FIG. 3 illustrates a user interface for displaying search results in both the unexpanded [301] and the expanded [302] states. When the search results are first displayed, the interface resembles the unexpanded search results listing [301]. The results are vertically tiled as rows [303] of uniform size. In each row is displayed the title of the associated search result [304], and a limited amount of metacontent related to the search result [305].

When the user selects a result [306], through an explicit selection (e.g., click/touch, navigate and select) or by navigating to the result's row and allowing the cursor to remain on the row for longer than a threshold time, the selected row expands [307] (the expanded portion of a row is also called the row's shelf). Inside the expanded row, the display shows additional metacontent about the selected search result, as described below. The metacontent displayed in the other rows is unchanged, allowing the user to see a number of results in a panoramic manner along with one result in some detail, as opposed to just one result in great detail (unlike, for example, prior art interface III [120]). This enables the user to review the expanded result, while still having access to summary information about the unexpanded results.

The metacontent associated with the expanded result that is shown in the expanded row [307] may include text [308], actions [309], and an image (if a suitable image exists) [310]. A horizontal array of action interfaces [309] appears below metacontent [308] associated with the result. These action interfaces represent a set of actions that are pertinent to the expanded result (e.g. “navigate to link”, “play video”, “find similar items”, etc.). Also, one of the action buttons preferably represents the “collapse row” action, which the user can select to collapse the expanded row and return to the unexpanded view [301]. If the metadata returned by the search engine includes an image or a video associated with the expanded result, the image or a still-frame of the video is also displayed in the expanded row [310].

Once the user finds a result of interest, he or she can act upon the result by selecting one of the actions from the horizontal array of action interfaces [309]. Because the actions are spatially collocated with the result, the actions are easy to access for both planar and random access interfaces. Rendering action choices only on the expanded row enables the user to navigate past results that are not of interest. By contrast, if action choices were rendered for each result, the user would have to navigate through more links before getting to the desired result, and less display space would be available to display metacontent.

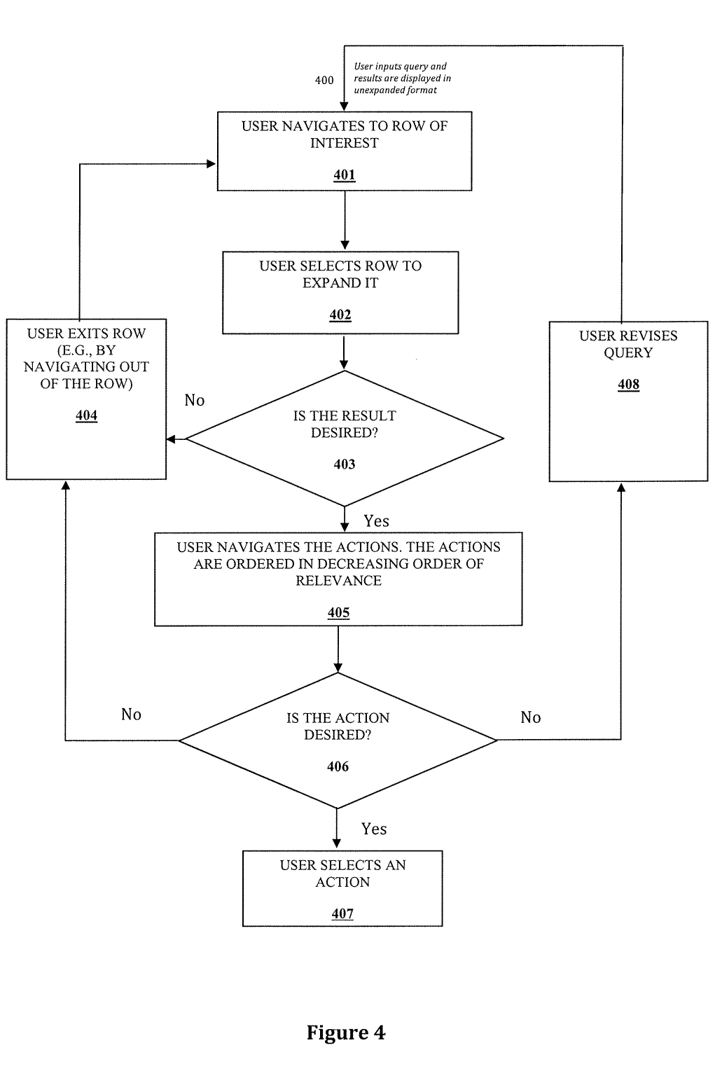

FIG. 4 is a flowchart that illustrates the user interface logic for discovering a result and acting upon it, according to certain embodiments of the invention. First, the user inputs text until a set of results are displayed [400]. Techniques for entering text on a limited input device include, but are not limited to, those disclosed in U.S. patent application Ser. No. 11/235,928, entitled Method and System For Processing Ambiguous, Multi-Term Search Queries, filed Sep. 27, 2005, herein incorporated by reference. The results may be displayed incrementally as the user types the characters. Alternatively, the user may explicitly perform a “send” operation to dispatch a query to a server after the user has completed the query text entry. Techniques for selecting a set of results responsive to the user's query include, but are not limited to, those disclosed in U.S. patent application Ser. No. 11/136,261, entitled Method and System For Performing Searches For Television Content Using Reduced Text Input, filed May 24, 2005, and U.S. patent application Ser. No. 11/246,432, entitled Method and System For Incremental Search With Reduced Text Entry Where The Relevance of Results is a Dynamically Computed Function of User Input Search String Character Count, filed Oct. 7, 2005, both of which are herein incorporated by reference.

The user then navigates to a result row of interest [401]. The user may elect to select the row and thereby expand the information displayed about the row [402]. The selection can be performed, for example, by manipulating a five-button interface to navigate to the row and pressing a select button, by using a scroll wheel interface to scroll to the row and pressing a select button, by clicking on the row using a mouse-like interface or touch screen, or by navigating to the row and allowing the cursor to linger over the row for greater than a threshold amount of time (whereupon the device selects the row automatically).

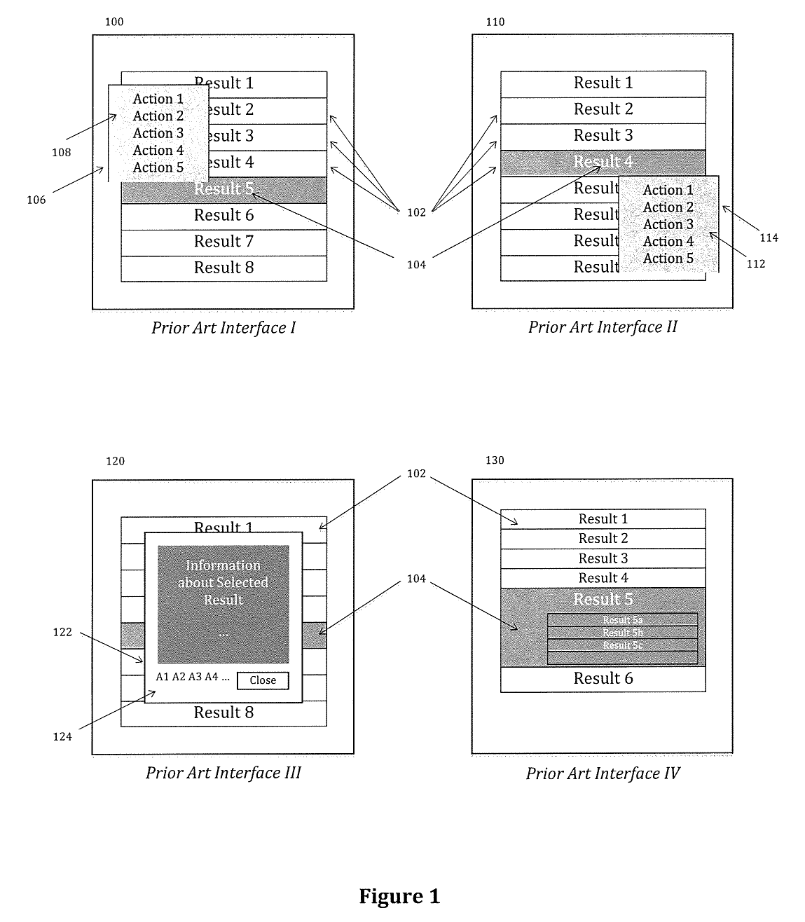

Selection of a row causes the row “shelf” to expand. The expanded shelf displays more metadata about the result associated with the selected row, as described above. This additional information helps the user decide if he or she wants act upon the result. For example, if the search were for “shakira” video clips and several results matched, some number of lines of metacontent for each result would be shown to enable a relatively large number of results to be visible to the user to facilitate visual identification of desired result. However, in some cases, this information may not be sufficient for the user to make a decision to play the clip. By expanding the shelf “in place” (as opposed to a popup, as in FIG. 1 [120]), more metacontent pertaining to the clip is displayed. This enables the user to make a more informed decision as to whether the selected result is the desired result [403].

On examination of the expanded shelf, if the user concludes the selected result is not the desired result, then the user can exit the selection [404] by, for example, navigating out of the row to another possible row of interest [401]. The user may also amend the search query to generate a revised list of results [408]. Upon exiting a row (e.g., by using an escape button of a scroll wheel interface), the expanded shelf automatically collapses, thereby maximizing the number of results shown in the result set. Amending the search query [408] also collapses the expanded shelf.

This iterative process of navigation and query refinement is made simpler by reducing the number of steps in the process, particularly by avoiding an explicit closing of an expanded row before proceeding to the next row. If the selected result is the desired one, the user can then navigate through the actions associated with the result [405]. For example, in devices utilizing a scroll wheel interface, once the result's shelf is expanded, the scroll wheel selects among the actions exposed on the expanded shelf. If the user finds the desired action (step 306), the user can select the action associated with the desired result [407]. If the desired action is not present, the user can exit the row, as described below [404], and start the next “navigate/select” cycle. Again, this occurs without explicit closing of the currently expanded result.

In the case of a device with a five-button interface, vertical navigation to an adjacent upper or lower row automatically collapses the currently expanded shelf. In the case of a linear scroll interface (as found in a BlackBerry-type device), navigating past the last action, navigating before the first action, clicking an escape button (e.g. the left arrow button), and/or selecting an action associated with the expanded row closes the currently expanded result. In the case of a touch interface (e.g., as in a iPhone-type device), touching another row collapses the currently expanded row. It is also the user's discretion to use a combination of the interfaces wherever more than one such interface is present (such as a Treo-type device with a touch screen and a five-button navigation interface).

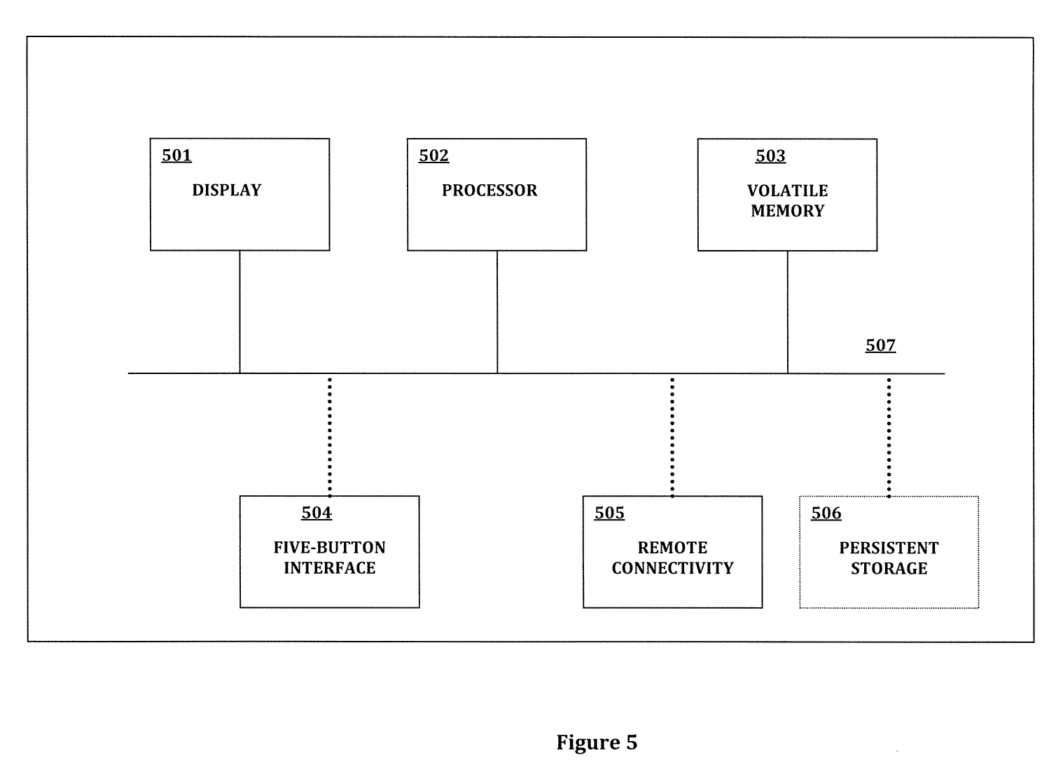

FIG. 5 is a diagram that depicts the various components of a user device, according to certain embodiments of the invention. The user device communicates with the user via a display [501] and a five-button interface [504]. A five-button interface is an exemplary interface for navigating through search results but the user device may also have overloaded keypads or other forms of input found in display-constrained devices. Computation is performed using a processor [502] that stores temporary information in a volatile memory store [503] and persistent data in a persistent memory store [506]. Either or both of these stores may hold the computer instructions for the processor to perform the logic described above. The device is operable to connect to a remote system using a remote connectivity module [505].

The presence of the action buttons in the expanded shelf [309] improve the usability of the search interface significantly, regardless of the type of interface used (planar navigation or random access navigation). The user's visual focus is maintained on the row of interest because the action choices are rendered directly adjacent to the metacontent of the result in the expanded shelf. This feature stands in contrast to the popup menus in the prior art that appear spatially disjoint.

Embodiments of the invention also have advantages over tree-like navigation interfaces (e.g., prior art interface IV [130]). The techniques described herein allow for selective expansion of a single result in a result list. This stands in contrast to a tree-like interface, which greatly increases the overall size of the results list when a branch is expanded. The selective expansion feature combined with the horizontal arrangement of selectable actions described herein enables the user to benefit from increased information about the expanded result and provides access to actions associated with the expanded result, while still retaining the list of unexpanded results in the user's focus. When used with a five-button navigation interface, this combination enables the user to rapidly scroll between results by using the up and down arrows of the interface, and to rapidly scroll between actions of an expanded result by using the left and right arrows. Because the expanded result is automatically collapsed when the user navigates off of it, the user is able to quickly discover the desired result and execute the desired action. This aspect is especially beneficial when used on display constrained devices, such as mobile telephones.

The techniques described herein reduce the amount of effort the user must expend to browse, review, and select an action associated with a desired search result. The present invention supports both forms of interaction (planar and random access), but does not require the presence of both.

It will be appreciated that the scope of the present invention is not limited to the above-described embodiments, but rather is defined by the appended claims; and that these claims will encompass modifications of and improvements to what has been described.

What is claimed is:

1) A user-interface method for displaying a set of search results on a user device having a limited display area and having a first set of directional control keys for vertical navigation, a second set of control keys for horizontal navigation, and a select-button, the method comprising:
a) Receiving a set of records that satisfy specified search criteria, where each record comprises a record title and associated metadata;
b) Subdividing the screen into rows, where each row displays a record title and a portion of the metadata associated with said record;
c) Navigating through the displayed rows, responsive to the first set of control keys, by highlighting one of the rows as the current row;
d) Expanding the current row responsive to explicit and implicit user selection so that it occupies a larger but limited portion of the screen while still allowing a substantial portion of the subdivided rows to remain on-screen without occluding their content, and using the larger space inside the expanded row to display a larger portion of the metadata for the associated record and to display a horizontal array of user actions;
e) Navigating through the displayed user actions, responsive to the second set of control keys, by highlighting one of the actions as the current action;
f) Performing the current user action, responsive to the select-button, such that a user of the device can simultaneously navigate through the displayed records and actions using only the two sets of directional control keys and select actions using the select-button.

2) The method according to claim 1, further comprising monitoring the amount of time that has elapsed since the current row was highlighted, wherein the current row is expanded if it has been highlighted for a predetermined amount of time, thereby triggering an implicit user selection.

3) The method according to claim 1, wherein the current row is expanded when an explicit user selection is triggered, responsive to the select-button.

4) The method according to claim 1, wherein the metadata displayed in each unexpanded row is limited to a predetermined size.

5) The method according to claim 1, wherein the metadata displayed in the expanded row is limited to a predetermined size.

6) The method according to claim 1, wherein the metadata displayed in the expanded row comprises an image.

7) The method according to claim 1, wherein the array of user actions comprises an unexpand-row action which, if selected, causes the display to revert to the state of the display immediately prior to the expansion of the current row.

8) The method according to claim 1, wherein the metadata for the expanded row comprises a Uniform Resource Locator, and the array of user actions comprises a navigate-to-link action which, if selected, navigates to said Uniform Resource Locator.

9) A user-interface system for displaying a set of search results on a user device having a limited display area and having a first set of directional control keys for vertical navigation, a second set of control keys for horizontal navigation, and a select-button, the system comprising:
a) Logic for receiving a set of records that satisfy specified search criteria, where each record comprises a record title and associated metadata;
b) Display logic for subdividing the screen into rows, where each row displays a record title and a portion of the metadata associated with said record;
c) Logic for navigating through the displayed rows, responsive to the first set of control keys, by highlighting one of the rows as the current row;
d) Logic for expanding the current row responsive to explicit and implicit user selection so that it occupies a larger but limited portion of the screen while still allowing a substantial portion of the subdivided rows to remain on-screen without occluding their content, and using the larger space inside the expanded row to display a larger portion of the metadata for the associated record and to display a horizontal array of user actions;
e) Logic for navigating through the displayed user actions, responsive to the second set of control keys, by highlighting one of the actions as the current action;
f) Logic for performing the current user action, responsive to the select-button, such that a user of the device can simultaneously navigate through the displayed records and actions using only the two sets of directional control keys and select actions using the select-button.

10) The system according to claim 9, further comprising logic for monitoring the amount of time that has elapsed since the current row was highlighted, wherein the current row is expanded if it has been highlighted for a predetermined amount of time, thereby triggering an implicit user selection.

11) The system according to claim 9, wherein the current row is expanded when an explicit user selection is triggered, responsive to the select-button.

12) The system according to claim 9, wherein the metadata displayed in each unexpanded row is limited to a predetermined size.

13) The system according to claim 9, wherein the metadata displayed in the expanded row is limited to a predetermined size.

14) The system according to claim 9, wherein the metadata displayed in the expanded row comprises an image.

15) The system according to claim 9, wherein the array of user actions comprises an unexpand-row action which, if selected, causes the display to revert to the state of the display immediately prior to the expansion of the current row.

16) The system according to claim 9, wherein the metadata for the expanded row comprises a Uniform Resource Locator, and the array of user actions comprises a navigate-to-link action which, if selected, navigates to said Uniform Resource Locator.
